(19) United States
(12) Patent Application Publication
(10) Pub. No.: US 2026/0097940 A1
(43) Pub. Date: Apr. 9, 2026

(54) ON-BOARD CHARGER SYSTEM AND METHOD

(71) Applicant: Toyota Material Handling, Inc., Columbus, IN (US)

(72) Inventors: Dennis Huffer, Indianapolis, IN (US); Laura Fundenberger, Columbus, IN (US); Kevin Shaw, Columbus, IN (US); Harold D. Stewart, JR., Columbus, IN (US); Paul Malcomb, Columbus, IN (US)

(21) Appl. No.: 19/354,212

(22) Filed: Oct. 9, 2025

Related U.S. Application Data
(60) Provisional application No. 63/705,382, filed on Oct. 9, 2024.

(51) Int. Cl. B66F 9/075; B60L 3/00; B60L 53/16; B60L 53/22

(52) U.S. Cl. CPC B66F 9/07504; B60L 3/00; B60L 53/22; B60L 53/16; B60L 2200/42

(57) ABSTRACT

A material handling vehicle is provided. The material handling vehicle includes a body and a charger assembly. The body defines an outer perimeter. The charger assembly is pivotably and removably mounted to the body. In a closed configuration, the charger assembly is disposed fully within the outer perimeter.

### CROSS REFERENCE TO RELATED APPLICATION

This application claims priority under 35 U.S.C. § 119 to U.S. Provisional Patent Application No. 63/705,382 filed on Oct. 9, 2024, the entire contents of which are incorporated herein by reference.

### BRIEF SUMMARY

This disclosure generally relates to material handling vehicles. More specifically, this disclosure relates to an on-board charger system and method of use with material handling vehicles.

### BACKGROUND

Material handling vehicles, such as forklifts, are often electrically powered and thus require regular charging. Batteries of conventional material handling vehicles are often charged at charging stations, which are traditionally located within a facility (e.g., a factory, a warehouse, a workshop, etc.).

In addition, electronic charging components are traditionally built into material handling vehicles. Thus, the material handling vehicle must be taken out of service during maintenance of the charging components. Conventional material handling systems and methods lack the ability to charge batteries in a location away from a charging station and to keep the material handling vehicle in service during the maintenance of charging components.

### SUMMARY

In an aspect of the present disclosure, a material handling vehicle is provided. The material handling vehicle includes a body and a charger assembly. The body defines an outer perimeter. The charger assembly is pivotably and removably mounted to the body. In a closed configuration, the charger assembly is disposed fully within the outer perimeter.

In some aspects, the charger assembly is pivotably mounted to a support post of the body via a clamp-on bracket assembly. In some aspects, the clamp-on bracket assembly is removable from the support post. In some aspects, the clamp-on bracket assembly includes a bracket configured to partially wrap around the support post. In some aspects, the clamp-on bracket assembly includes a spacer coupled to the bracket. In some aspects, the charger assembly is removable from the clamp-on bracket assembly via a hinge pin. In some aspects, a hinge fork of the charger assembly pivotably engages the clamp-on bracket assembly and the hinge pin. In some aspects, a clamp-on bracket assembly mounted to a support post of the body latchably receives the charger assembly. In some aspects, a latch plate of the charger assembly is slidably received by a latch lobe extending from the clamp-on bracket assembly. In some aspects, the charger assembly is retained in the closed configuration via a spring pin mounted to the body and engaging the charger assembly. In some aspects, the spring pin engages one of a latch plate and a hinge fork of the charger assembly. In some aspects, an alternating current electrical plug extends rearwardly from the charger assembly. In some aspects, a charger is disposed in a housing of the charger assembly. In some aspects, electrical ports of the charger are oriented downwardly. In some aspects, a top panel includes vents.

In another aspect of the present disclosure, a material handling vehicle is provided. The material handling vehicle includes a body and a charging system. The charging system includes a charger assembly and a controller. The charger assembly is pivotably and removably mounted to the body. The charger assembly includes an alternating current electrical plug and a charger in electrical communication with the alternating current electrical plug. The controller is mounted to the body and in electrical communication with the charger.

In some aspects, the controller includes an interlock configured to prevent movement of the material handling vehicle when an alternating current power source is connected to the alternating current electrical plug. In some aspects, the charger includes a plurality of electrical ports extending downwardly.

In a further aspect of the present disclosure, a charger assembly is provided. The charger assembly includes a housing and a charger. The housing includes a top panel configured to provide ventilation, a front panel defining a first opening for electrical cables, a side panel defining a second opening configured as a handle, and a hinge flange configured to removably and pivotably engage a bracket. The charger is mounted within the housing and includes a plurality of electrical ports extending downwardly.

In some aspects, an alternating current electrical plug supported by the housing is in electrical communication with the charger.

### BRIEF DESCRIPTION OF DRAWINGS

The accompanying drawings, which are incorporated in and form a part of this specification, illustrate embodiments of the disclosure and, together with the description, serve to explain the principles of embodiments of the disclosure:

FIG. 1 is an isometric view of a material handling vehicle with a charger assembly according to an embodiment;

FIG. 2 is a side elevational view of the material handling vehicle of FIG. 1;

FIG. 3 is a top plan view of the material handling vehicle of FIG. 1;

FIG. 4 is a partial rear elevational view of the material handling vehicle of FIG. 1, focusing on a rear panel of the charger assembly;

FIG. 5 is a partial cross-sectional view of the material handling vehicle of FIG. 1 taken along line A-A of FIG. 2, focusing on a front panel of the charger assembly;

FIG. 6 is a partial cross-sectional view of the material handling vehicle of FIG. 1 taken along line B-B of FIG. 2, focusing on a bottom panel of the charger assembly;

FIG. 7 is a partial cross-sectional view of the material handling vehicle of FIG. 1 taken along line C-C of FIG. 4, focusing on a first side panel of the charger assembly;

FIG. 8 is a partial cross-sectional view of the material handling vehicle of FIG. 1 taken along line D-D of FIG. 4, focusing on a second side panel of the charger assembly;

FIG. 9 is a partial isometric view of the material handling vehicle of FIG. 1, focusing on a first mounting bracket installed on a first support post of the material handling vehicle of FIG. 1;

FIG. 10A is a partial top isometric view of the material handling vehicle of FIG. 1, focusing on a second mounting bracket installed on a second support post of the material handling vehicle of FIG. 1;

FIG. 10B is a partial bottom isometric view of the material handling vehicle of FIG. 1, focusing on the second mounting bracket installed on the second support post of the material handling vehicle of FIG. 1;

FIG. 11 is a partial cross-sectional view of the material handling vehicle of FIG. 1 taken along line E-E of FIG. 4, focusing on the charger assembly;

FIG. 12 a partial cross-sectional view of the material handling vehicle of FIG. 1 taken along line F-F of FIG. 4, focusing on the charger assembly;

FIG. 13 is a partial cross-sectional view of the material handling vehicle of FIG. 1 taken along line G-G of FIG. 4, focusing on the charger assembly;

FIG. 14 is a bottom view of a primary charger of the material handling vehicle of FIG. 1;

FIG. 15 is an isometric view of charger assembly of FIG. 1 in an open configuration relative to a body of the material handling vehicle of FIG. 1;

FIG. 16 is an isometric view of the charger assembly of FIG. 1 removed from the body of FIG. 15; and

FIG. 17 is a block diagram of a charging system of the material handling vehicle of FIG. 1.

### DETAILED DESCRIPTION

The following discussion is presented to enable a person skilled in the art to make and use embodiments of the disclosure. Various modifications to the illustrated embodiments will be readily apparent to those skilled in the art, and the generic principles herein can be applied to other embodiments and applications without departing from embodiments of the disclosure. Thus, embodiments of the disclosure are not intended to be limited to embodiments shown but are to be accorded the widest scope consistent with the principles and features disclosed herein. The following detailed description is to be read with reference to the figures, in which like elements in different figures have like reference numerals. The Figures, which are not necessarily to scale, depict selected embodiments and are not intended to limit the scope of embodiments of the disclosure. Skilled artisans will recognize the examples provided herein have many useful alternatives and fall within the scope of embodiments of the disclosure.

Before any embodiments of the disclosure are explained in detail, it is to be understood that the disclosure is not limited in its application to the details of construction and the arrangement of components set forth in the following description or illustrated in the attached drawings. The disclosure is capable of other embodiments and of being practiced or of being carried out in various ways. Also, it is to be understood that the phraseology and terminology used herein are for the purpose of description and should not be regarded as limiting. For example, the use of “including,” “comprising,” or “having” and variations thereof herein is meant to encompass the items listed thereafter and equivalents thereof as well as additional items.

As used herein, unless otherwise specified or limited, the terms “mounted,” “connected,” “supported,” and “coupled” and variations thereof are used broadly and encompass both direct and indirect mountings, connections, supports, and couplings. Further, unless otherwise specified or limited, “connected” and “coupled” are not restricted to physical or mechanical connections or couplings.

Turning now to an overview of the present disclosure, on-board charging is an in-field solution for charging material handling vehicles in environments or warehouses that do not have permanent charging stations. In some instances, an on-board charger assembly uses standard EVSE Type 1 electrical charging plugs. In some instances, the on-board charger assembly is compatible with standard 240 Volt electrical plugs via one or more adapters. Further, an interlock system of the material handling vehicle may communicate with the on-board charger assembly to prevent the operation of the material handling vehicle during battery charging. Additionally, the on-board charger assembly is configured to fit within a perimeter of a counterweight of the material handling vehicle.

The on-board charger assembly may also include clamp-on bracket assemblies, which facilitate installation of the on-board charger assembly onto existing material handling vehicles. These clamp-on bracket assemblies permit the on-board charger assembly to swing outwardly relative to the material handling vehicle to provide access for maintenance of the on-board charger assembly and/or the material handling vehicle. Further, the on-board charger assembly may be moved from one material handling vehicle to another via the clamp-on bracket assemblies. A housing of the on-board charger assembly may include one or more handles to facilitate the installation, retrofit and/or removal of the on-board charger assembly relative to a material handling vehicle.

Moreover, ports in the housing of the on-board charger assembly are oriented downwardly to prevent the ingress of water, dust, debris, etc. In some instances, the housing also defines one or more vents for cooling internal electronic components.

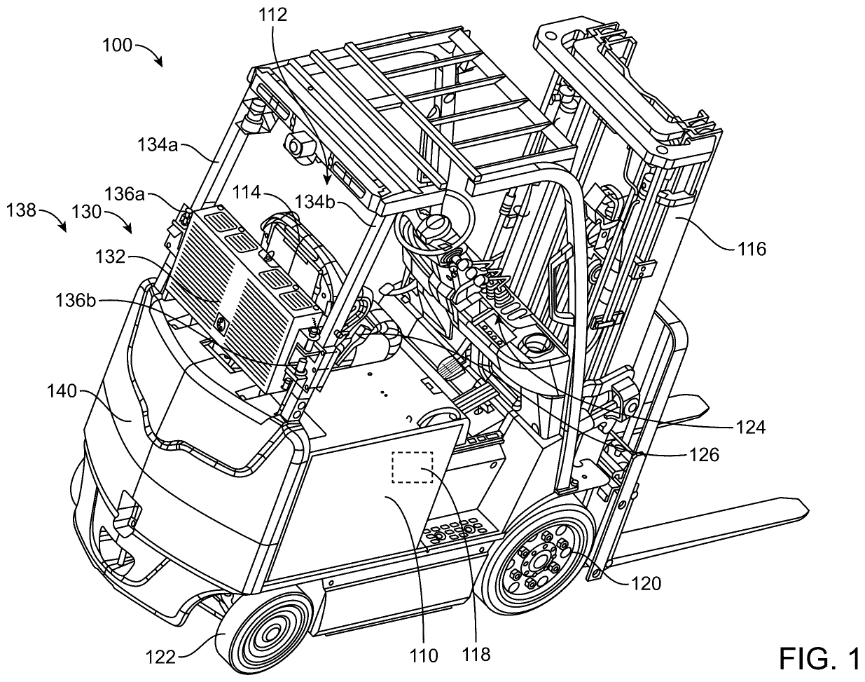

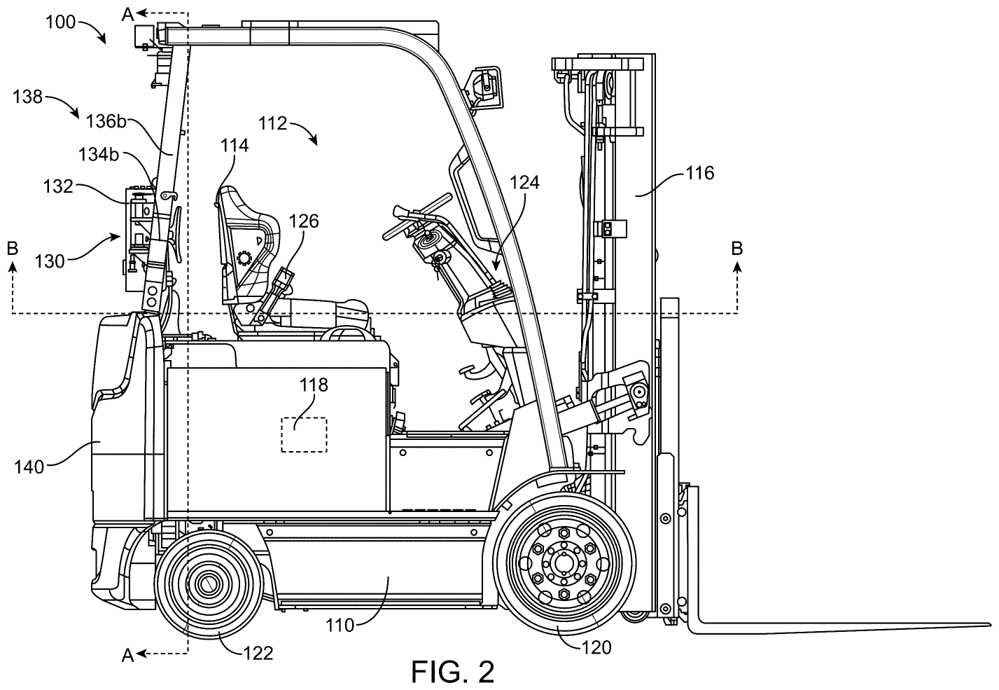

FIGS. 1 and 2 illustrate a material handling vehicle 100 according to one embodiment. The material handling vehicle 100 can comprise a body 110, an operator cab 112, a driver's seat 114, a mast 116, a controller 118, tires 120, 122, and a control panel 124. In some embodiments, the material handling vehicle 100 is operated by a driver who sits in the driver's seat 114, but in some other forms, the material handling vehicle 100 can operate autonomously or via remote control. In the manual driver operation embodiments, the driver can use the control panel 124 to control the material handling vehicle 100, and the control panel 124 may include a steering wheel, an accelerator pedal, a brake pedal, and one or more control levers. For example, the control panel 124 may be used to drive, steer, stop, and/or change the direction of operation (e.g., forward, reverse) of the material handling vehicle 100. The material handling vehicle 100 may also have additional controls and/or instruments not pictured that the driver may use to direct the material handling vehicle 100 in different ways based on the task at hand. Additionally, the driver's seat 114 may have a seat belt 126 and an operator presence sensor, such as a contact or pressure switch.

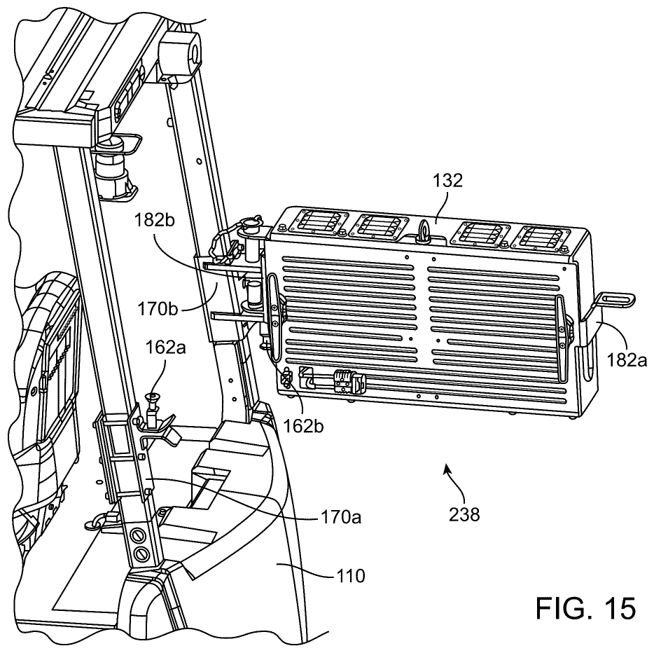

The material handling vehicle 100 includes a charging system 130 that is provided in the form of the controller 118 and charger assembly 132. The charger assembly 132 is pivotably and removably mounted to the body 110. More specifically, in some instances, the charger assembly 132 is mounted to a first support post 134a (shown in FIG. 1) and a second support post 134b via a first clamp-on bracket assembly 136a (shown in FIG. 1) and a second clamp-on bracket assembly 136b, respectively. Thus, the charger assembly 132 is carried on board the material handling vehicle 100. The first clamp-on bracket assembly 136a and the second clamp-on bracket assembly 136b are selectively couplable to the support posts 134a, 134b, such that the entire charger assembly 132 can be positioned anywhere along the support posts 134a, 134b or removed entirely from the vehicle. In this way, the charger assembly 132 is adaptable or retrofittable to a variety of vehicles and easily interchanged between vehicles. Further, the charger assembly 132 is moveable between a closed configuration 138 and an open configuration 238 (shown in FIG. 15).

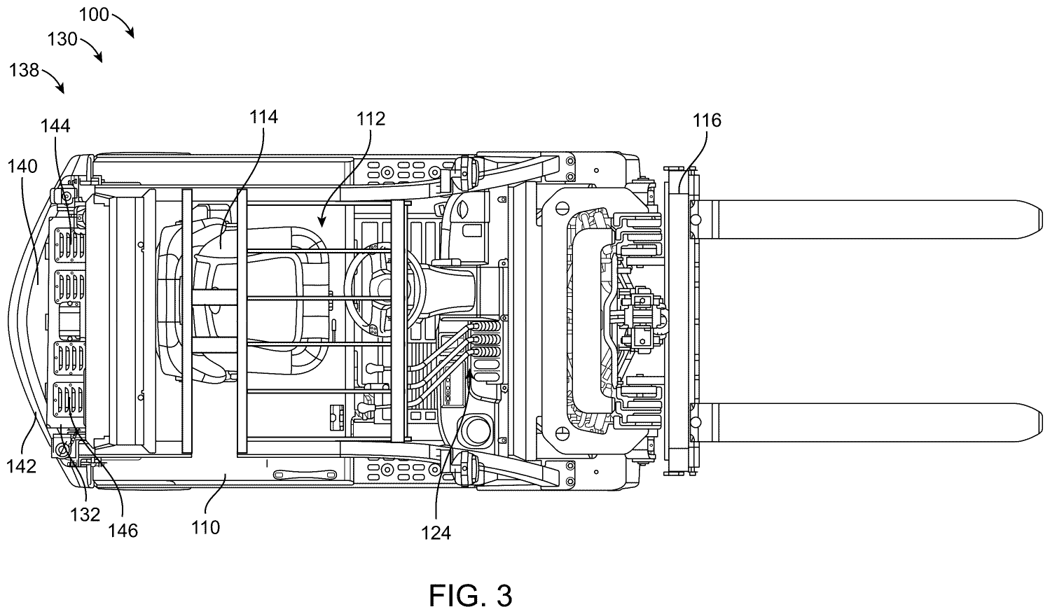

The material handling vehicle 100 also includes a counterweight 140 mounted to the body 110. It should be appreciated that the charger assembly 132 is located fully inboard of an outer perimeter 142 of the material handling vehicle 100, as shown best from the top view of FIG. 3. Thus, in the closed configuration 138, the charger assembly 132 does not extend beyond the outer perimeter 142 of the counterweight 140 to help prevent operators, warehouse personnel, or other environmental structures from colliding with the charger assembly 132. It should also be appreciated that an upper panel 144 of a housing 146 of the charger assembly 132 can be solid and/or sealed (e.g., defines no openings). Accordingly, the upper panel 144 can mitigate the ingress of water, dust, debris, etc., into the charger assembly 132. In some embodiments, the upper panel 144 is vented. Accordingly, the upper panel 144 can aid in providing airflow, ventilation, and/or cooling to the charger assembly 132.

It is to be understood that although FIGS. 1-3 show the material handling vehicle 100 as a counterbalance-type forklift truck, this is not to be considered limiting. The material handling vehicle 100 may be provided in the form of any material handling vehicle or other vehicle used to transport materials. For example, the material handling vehicle 100 may be provided in the form of a reach truck, a stacker, a pallet truck, or an order picker.

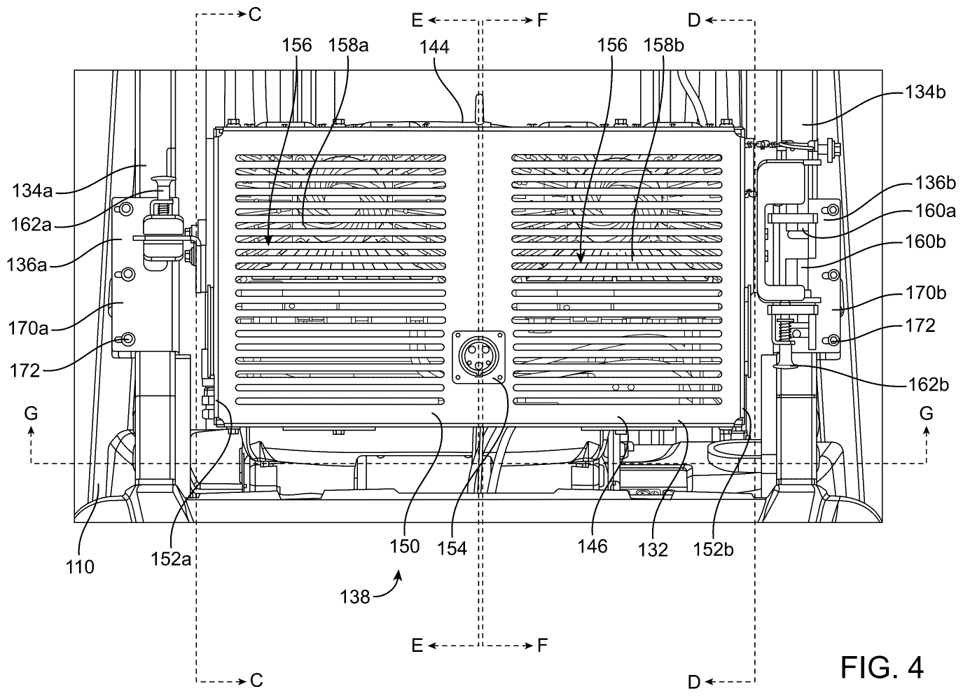

With reference to FIG. 4, the housing 146 further includes a rear panel 150 connected to the upper panel 144, a first side panel 152a, and a second side panel 152b. The rear panel 150 supports an alternating current (AC) electrical plug 154 (e.g., EVSE Type 1, 240 Volt, etc.) and defines a plurality of cooling vents 156. A primary charger 158a and a secondary charger 158b are located within and protected by the housing 146. Although the illustrated example of FIG. 4 depicts two chargers, the primary charger 158a and the secondary charger 158b, it should be understood that the charger assembly 132 may include any number of chargers placed in any arrangement relative to one another and/or the housing. In some instances, these chargers are supported by the housing 146. In some instances, one or more of the chargers is disposed within the housing 146 (as shown in FIG. 4). In some instances, one or more of the chargers is external to the housing 146 (not shown). In some instances, the number and/or arrangement of chargers in the charger assembly 132 is based on an application of the material handling vehicle 100. In some instances, the number and/or arrangement of chargers in the charger assembly 132 is for general purpose use of the material handling vehicle 100.

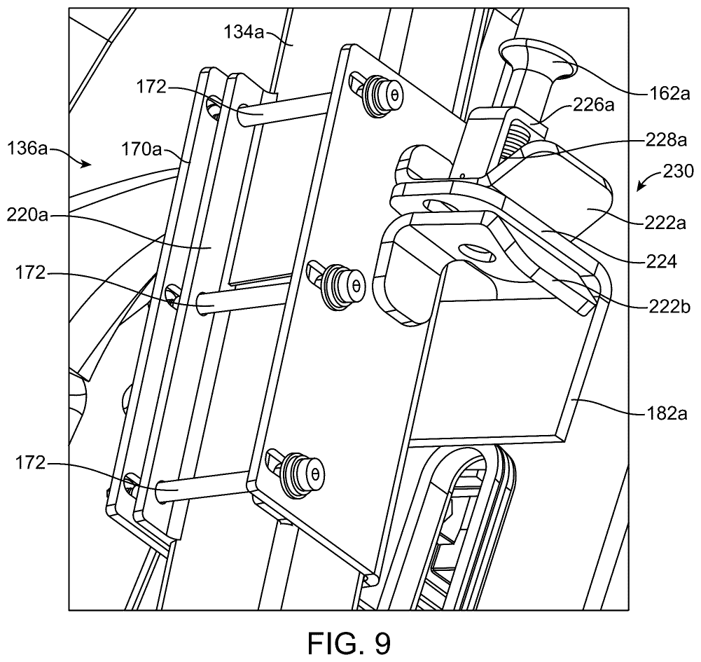

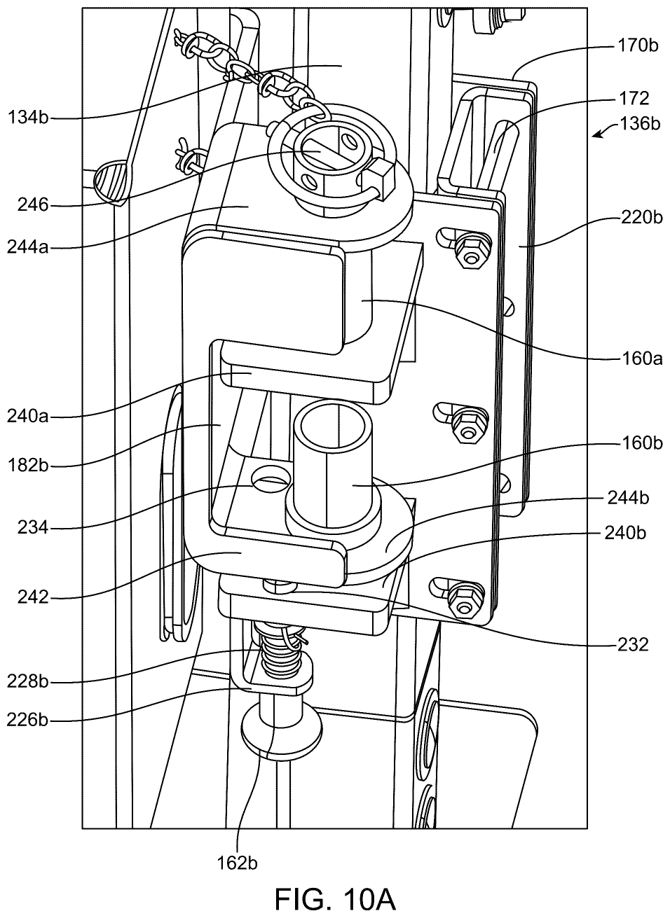

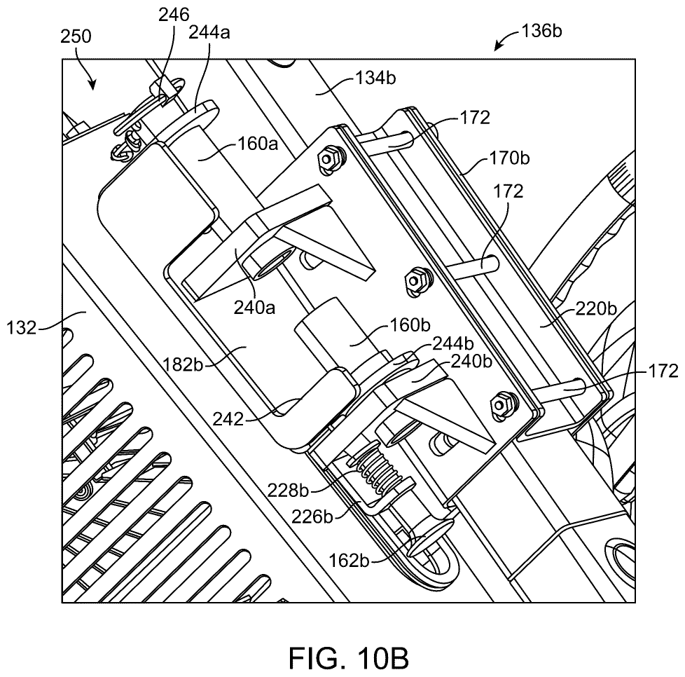

The charger assembly 132 is latchably received by the first clamp-on bracket assembly 136a. Similarly, the charger assembly 132 is hingedly and/or pivotably connected to the second clamp-on bracket assembly 136b via upper and lower hinge pins 160a, 160b. A first spring pin 162a selectively couples the charger assembly 132 to the first clamp-on bracket assembly 136a and prevents the charger assembly 132 from pivoting relative to the second clamp-on bracket assembly 136b, as explained in detail below with respect to FIG. 9. Further, a second spring pin 162b selectively prevents the charger assembly 132 from pivoting relative to the second clamp-on bracket assembly 136b, as explained in further detail below with respect to FIGS. 10A and 10B.

A user may selectively pull the first spring pin 162a upwardly to release the charger assembly 132 from the first clamp-on bracket assembly 136a and enable pivoting of the charger assembly 132 relative to the second clamp-on bracket assembly 136b. Thus, when the first spring pin 162a is pulled, the charger assembly 132 may pivot relative to the second support post 134b from the closed configuration 138 to the open configuration 238 (shown in FIG. 15). From the open configuration 238, the charger assembly 132 may be completely detached from the second support post 134b by lifting the charger assembly 132 along the upper and lower hinge pins 160a, 160b and away from the second clamp-on bracket assembly 136b. Similarly, the charger assembly 132 may be installed by slidably mounting the charger assembly 132 onto the upper and lower hinge pins 160a, 160b and rotating the charger assembly 132 into the closed configuration 138.

A first bracket 170a of the first clamp-on bracket assembly 136a wraps partially around and is tightened against the first support post 134a via fasteners 172. Similarly, a second bracket 170b of the second clamp-on bracket assembly 136b wraps partially around and is tightened against the second support post 134b via fasteners 172. In some forms, the fasteners 172 are provided in the form of threaded mechanical fasteners such as bolts and nuts. In some forms, the fasteners 172 are provided in the form of a different type of selectively removable mechanical coupling. Thus, the first clamp-on bracket assembly 136a and the second clamp-on bracket assembly 136b serve as mounting adapters for mounting the charger assembly 132 to the body 110.

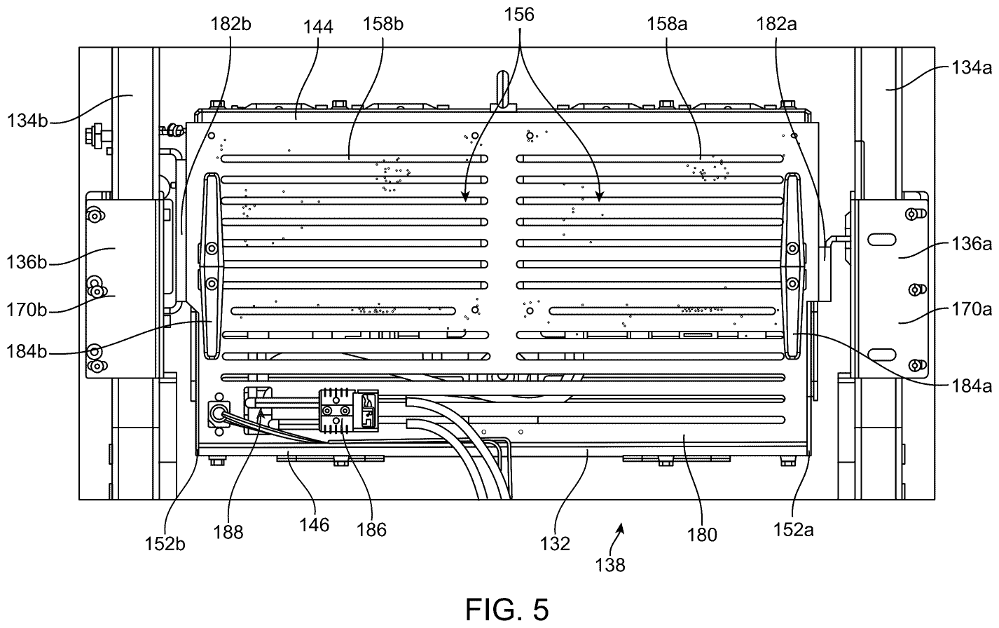

With reference to FIG. 5, the housing 146 further includes a front panel 180 connected to the upper panel 144, the first side panel 152a, and the second side panel 152b. The front panel 180 defines additional cooling vents 156. A first hinge flange 182a and a second hinge flange 182b extend from the front panel 180 and connect to the first clamp-on bracket assembly 136a and the second clamp-on bracket assembly 136b, respectively. Further, one or more electrical cords (such as the cords corresponding to the power input to the AC electrical plug 154) may be stored and/or wound around a first cleat 184a and a second cleat 184b, which are mounted to the front panel 180. Electrical connectors 186 may be mounted to and/or extend through the front panel 180. Further, electrical cords may extend through the front panel 180 via one or more openings 188.

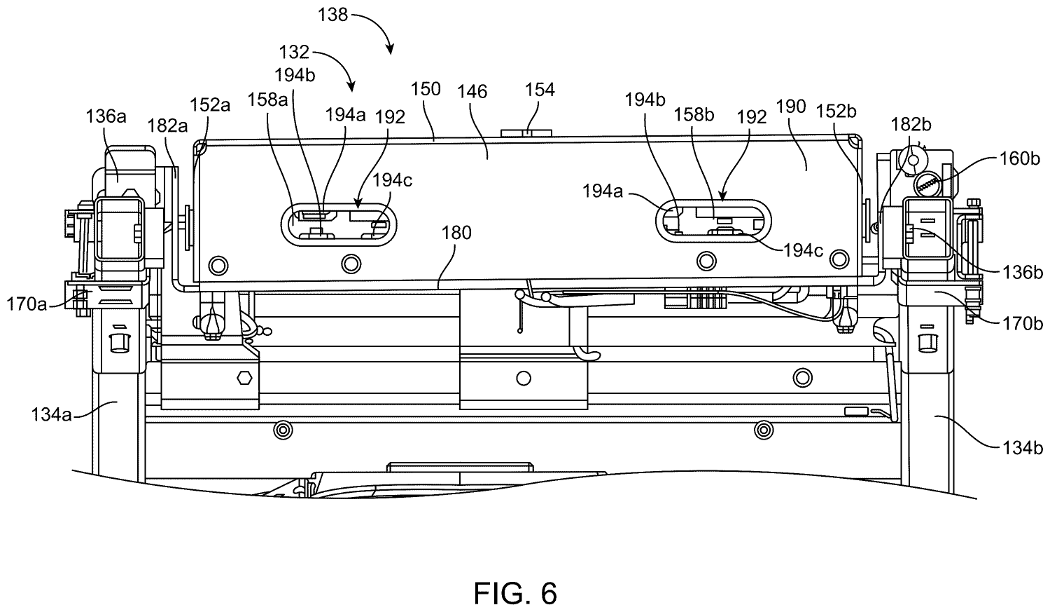

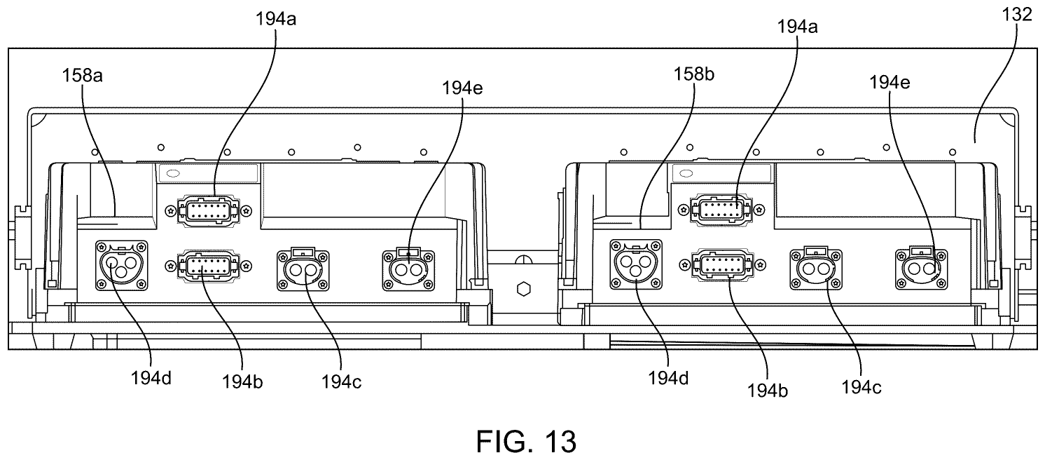

Referring now to FIG. 6, the housing 146 further includes a bottom panel 190 connected to the rear panel 150, the first side panel 152a, the second side panel 152b, and the front panel 180. The bottom panel 190 defines one or more openings 192 through which one or more electrical cables may extend. In some embodiments, the openings 192 are rounded, ovular, ellipsoid, rectilinear, etc. More specifically, the first hinge flange 182a and second hinge flange 182b extend outwardly and rearwardly from the front panel 180. Each of the primary charger 158a and the secondary charger 158b have a plurality of electrical ports 194a-194e (see FIG. 13) that are disposed within the housing 146 and are thus protected by the bottom panel 190. Additionally, the AC electrical plug 154 extends rearwardly from the rear panel 150. In some embodiments, the AC electrical plug 154 is configured to be flush with the rear panel 150 or recessed into the rear panel 150 such that no portion of the AC electrical plug 154 extends outward from the rear panel 150.

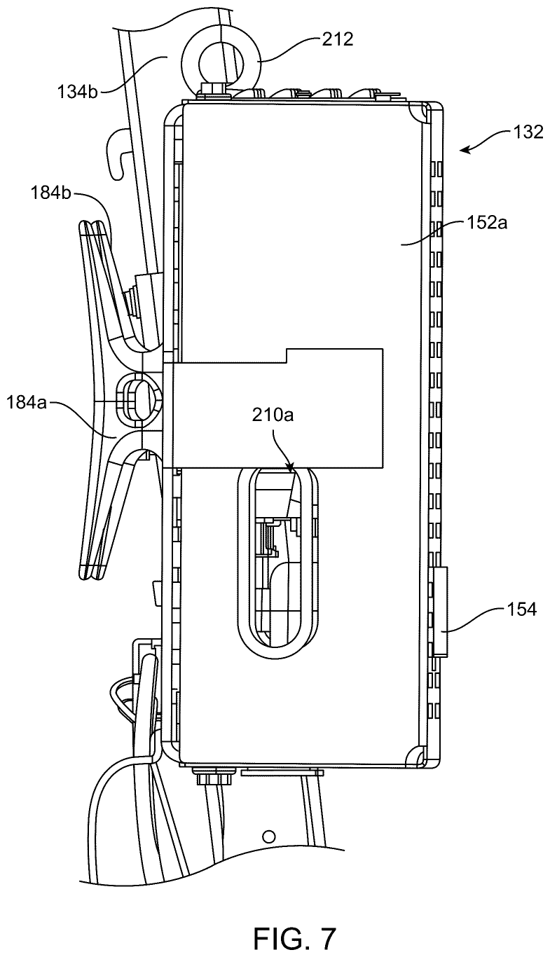

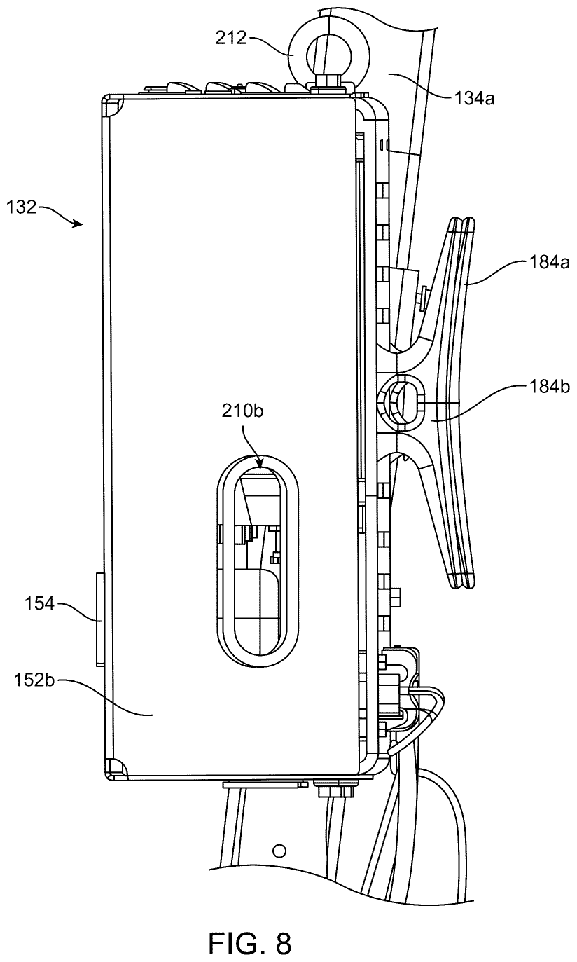

With reference to FIG. 7, the first side panel 152a defines a first handle opening 210a. In some embodiments, the first handle opening 210a is rounded, ovular, ellipsoid, rectilinear, etc. A user may grasp the charger assembly 132 via the first handle opening 210a to move (e.g., remove, install, retrofit) the charger assembly 132 relative to the body 110. Similarly, with reference to FIG. 8, the second side panel 152b defines a second handle opening 210b. In some embodiments, the second handle opening 210b is rounded, ovular, ellipsoid, rectilinear, etc. A user may grasp the charger assembly 132 via the second handle opening 210b to move (e.g., remove, install, retrofit) the charger assembly 132 relative to the body 110. Accordingly, the charger assembly 132 provides a means for a two-person lift to assist with the installation process. Additionally, a crane loop 212 may be mounted to the housing 146 to provide a lifting point for the charger assembly 132.

With reference to FIG. 9, the first clamp-on bracket assembly 136a further includes a first spacer 220a against which the first bracket 170a is coupled to assist with securing the first clamp-on bracket assembly 136a to the first support post 134a. The fasteners 172 extend through the first bracket 170a and the first spacer 220a. In some forms, the first bracket 170a includes slots that allow the first spacer 220a to be adjusted toward and away from the first support post 134a. Thus, the first clamp-on bracket assembly 136a wraps around the first support post 134a. Further, an upper latch lobe 222a and a lower latch lobe 222b are fixed to and extend rearwardly from the first bracket 170a. The upper latch lobe 222a and the lower latch lobe 222b are spaced apart from one another and are slightly bent or curved to latchingly receive a latch plate 224 of the first hinge flange 182a.

The first spring pin 162a extends through a first retainer hook 226a, which is connected to the upper latch lobe 222a. A first spring 228a engages the first spring pin 162a and the first retainer hook 226a to urge the first spring pin 162a into a latched configuration 230 in which the first spring pin 162a extends through the upper latch lobe 222a, the latch plate 224, and the lower latch lobe 222b. In the latched configuration 230, the first spring pin 162a substantially prevents the latch plate 224 from moving relative to the upper latch lobe 222a and the lower latch lobe 222b. Thus, the first spring pin 162a retains the latch plate 224 between the upper latch lobe 222a and the lower latch lobe 222b.

With reference to FIGS. 10A and 10B, the second clamp-on bracket assembly 136b further includes a second spacer 220b against which the second bracket 170b is coupled to assist with securing the second clamp-on bracket assembly 136b to the second support post 134b. The fasteners 172 extend through the second bracket 170b and the second spacer 220b. In some forms, the second bracket 170b includes slots that allow the second spacer 220b to be adjusted toward and away from the second support post 134b. Thus, the second clamp-on bracket assembly 136b wraps around the second support post 134b. Further, an upper hinge ledge 240a and a lower hinge ledge 240b are fixed to and extend rearwardly from the second bracket 170b. The upper hinge pin 160a and the lower hinge pin 160b are fixed to and extend from the upper hinge ledge 240a and the lower hinge ledge 240b, respectively. The upper hinge ledge 240a and the lower hinge ledge 240b are spaced apart from one another to hingedly receive a hinge fork 242 of the second hinge flange 182b. The hinge fork 242 includes an upper hinge lobe 244a and a lower hinge lobe 244b. The upper hinge lobe 244a pivotably engages the upper hinge pin 160a. The lower hinge lobe 244b pivotably engages the lower hinge pin 160b and is supported by the lower hinge ledge 240b. The space between the upper hinge pin 160a and the lower hinge pin 160b allows the lower hinge lobe 244b to slide up and off of the lower hinge pin 160b for the removal of the charger assembly 132. In some instances, the upper hinge pin 160a is longer than the lower hinge pin 160b. In some instances, a retainer pin 246 (e.g., clip, cotter pin, etc.) extends through the upper hinge pin 160a to retain the hinge fork 242 on the second bracket 170b.

The second spring pin 162b extends through a second retainer hook 226b, which is connected to the lower hinge ledge 240b. A second spring 228b engages the second spring pin 162b and the second retainer hook 226b to urge the second spring pin 162b toward the lower hinge lobe 244b. The lower hinge ledge 240b includes a first bore 232 that allows the second spring pin 162b to extend upward through the lower hinge ledge 240b to the lower hinge lobe 244b. Further, the lower hinge lobe 244b includes a second bore 234 through which the second spring pin 162b can extend when the charger assembly 132 is rotated to the open configuration 238 (shown in FIG. 15). Accordingly, when the charger assembly 132 is in the open configuration 238, the second spring pin 162b is urged through the first bore 232 and the second bore 234 by the second spring 228b, which allows the charger assembly 132 to be locked in the open configuration 238. This allows operators to perform maintenance, inspections, and the like with the charger assembly 132 in the open configuration 238 without concern that the charger assembly 132 will pivot.

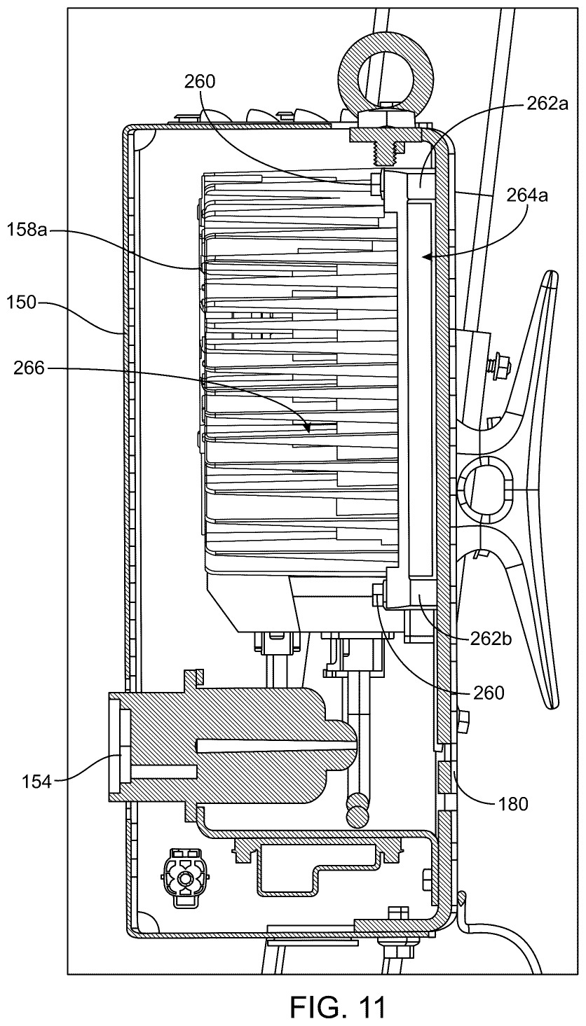

With reference to FIG. 11, the primary charger 158a is mounted to the front panel 180 via fasteners 260. In some instances, the fasteners 260 are threaded. The fasteners 260 respectively extend through mounting feet 262a, 262b, which offset the primary charger 158a from the front panel 180 to define a first air gap 264a. In some instances, the mounting feet 262a, 262b include an elastomer material and thus dampen vibrations from the front panel 180 to the primary charger 158a. Additionally, the primary charger 158a includes a plurality of cooling fins 266.

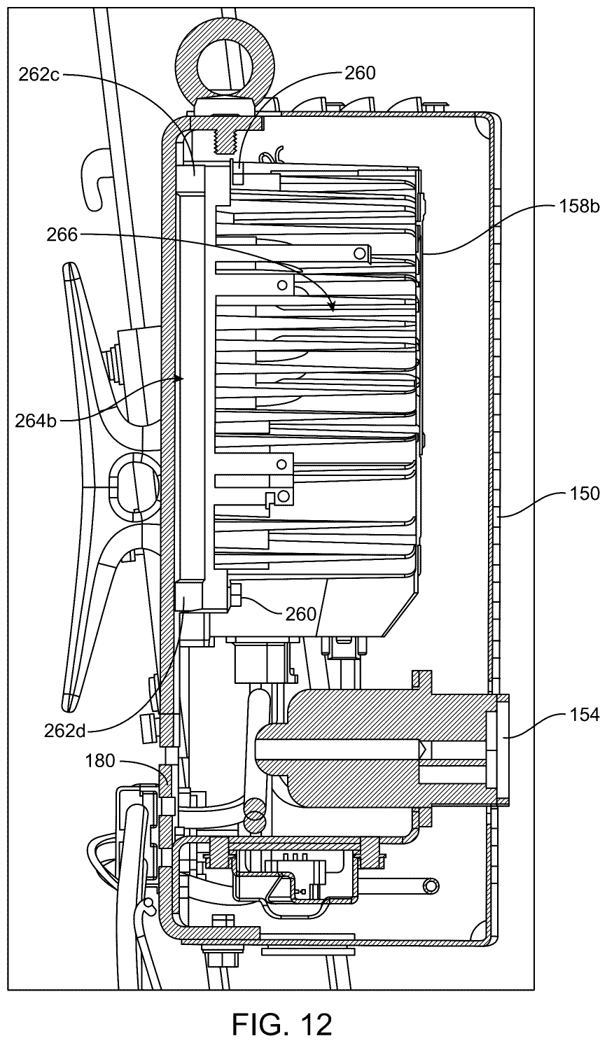

With reference to FIG. 12, similarly, the secondary charger 158b is mounted to the front panel 180 via fasteners 260, which respectively extend through mounting feet 262c, 262d. Thus, the secondary charger 158b is offset from the front panel 180 to define a second air gap 264b. In some instances, the mounting feet 262c, 262d include an elastomer material and thus dampen vibrations from the front panel 180 to the secondary charger 158b. Additionally, the secondary charger 158b has cooling fins 266.

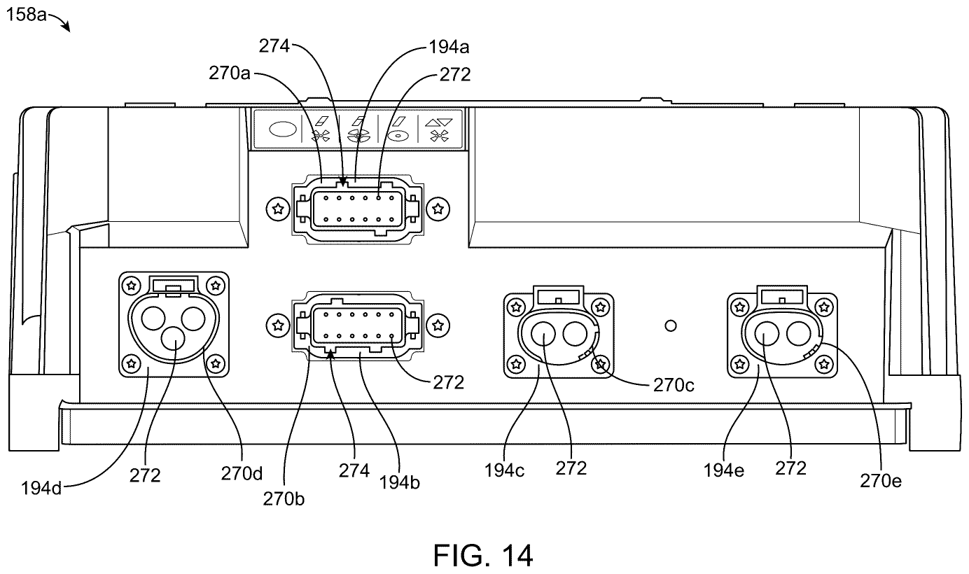

With reference to FIG. 13, each of the primary charger 158a and the secondary charger 158b are arranged side-by-side in the charger assembly 132. The electrical ports 194a-194e extend downwardly to mitigate the ingress of water, dust, debris, etc. More specifically, as shown in FIG. 14, the electrical ports 194a-194e each have a receptacle housing 270a-270e and a plurality of pins 272. The receptacle housings 270a-270e can be provided in various curved or rectilinear forms. Further, one or more of the receptacle housings 270a-270e may define various keyways 274. Additionally, one or more of the receptacle housings 270a-270e may be shaped as poka-yokes. The electrical ports 194a-194e are configured to transmit one or more of electrical power, signals, data, etc. As a non-limiting example, one or more of the electrical ports 194a-194e can be provided in the form of an AMPHENOL DTI Powerlock 4.0 connector for DC output, a DC auxiliary output, or an AC input, or a 12-pin TE DEUTSCH DT series connector for CAN communication or signals for an interlock system, among other purposes. The electrical ports 194a-194e can also be provided in the form of other known battery charger connectors.

FIG. 15 illustrates the charger assembly 132 in the open configuration 238. To move the charger assembly 132 into the open configuration 238 from the closed configuration 138 (shown in FIG. 1), the first spring pin 162a is actuated. When the first spring pin 162a is actuated, the first hinge flange 182a is released from the first bracket 170a. When the charger assembly 132 pivots into the open configuration 238, the second spring pin 162b snaps into engagement with the second hinge flange 182b. Thus, as described above with respect to FIGS. 10A and 10B, the charger assembly 132 locks into place in the open configuration 238.

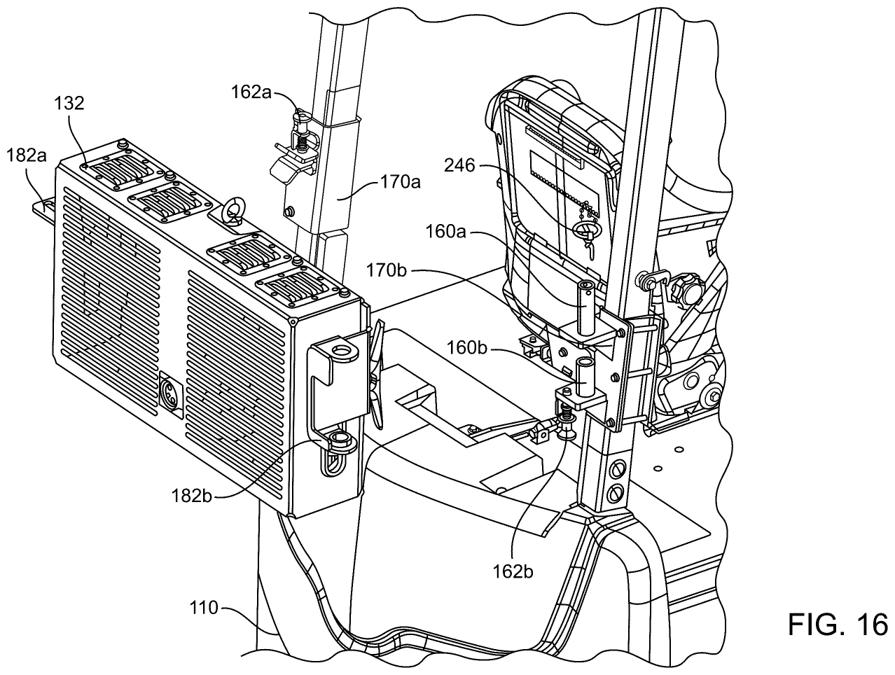

FIG. 16 illustrates the charger assembly 132 removed from the body 110. To remove the charger assembly 132 from the body 110, the charger assembly 132 is placed into the open configuration 238 (shown in FIG. 15). From the open configuration 238, the retainer pin 246 is removed from the upper hinge pin 160a, which permits the second hinge flange 182b to slide relative to the second bracket 170b along the upper hinge pin 160a and the lower hinge pin 160b. Once the second hinge flange 182b clears the upper hinge pin 160a and the lower hinge pin 160b, the charger assembly 132 may be moved away from the body 110.

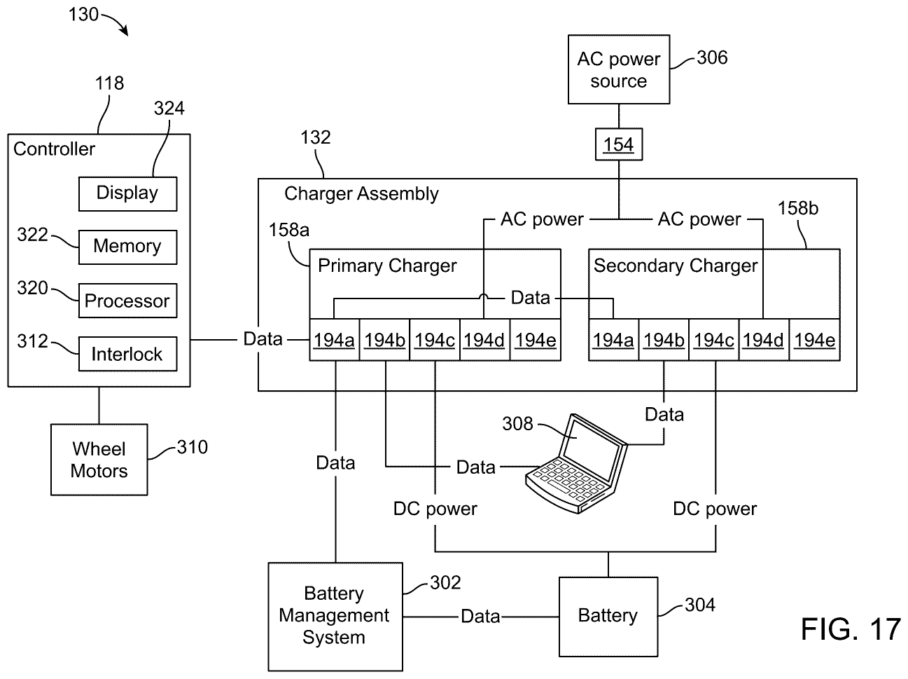

Referring now to FIG. 17, the charging system 130 of the material handling vehicle 100 of FIG. 1 includes the charger assembly 132 in electrical communication with the controller 118, a battery management system 302, a battery 304, and an AC power source 306. In some forms, the charger assembly 132 can be electrically coupled to a computing device 308 (e.g., laptop computer, desktop computer, smartphone, mobile device, handheld device, specialized programming tool, etc.). The controller 118 is in further electrical communication with wheel motors 310 and, in some instances, includes an interlock 312. In some instances, the interlock 312 is associated with the seat belt 126 (shown in FIG. 2). The battery management system 302 is in further electrical communication with the battery 304. The electrical ports 194a-194e of the primary charger 158a and the secondary charger 158b may be coupled, wired or wirelessly, to the controller 118, the battery management system 302, the battery 304, and the computing device 308. The charger assembly 132, the controller 118, and the battery management system 302 may communicate with one another, for example, via Controller Area Network (CAN bus) communication.

The AC power source 306 provides AC electrical power to the charger assembly 132 via the AC electrical plug 154. AC electrical power is further delivered to the primary charger 158a and the secondary charger 158b via one or more of their respective electrical ports 194a-194e (e.g., electrical ports 194d). Further, the primary charger 158a and the secondary charger 158b convert the AC electrical power and output direct current (DC) electrical power to the battery 304 via one or more of their respective electrical ports 194a-194e (e.g., electrical ports 194c). The primary charger 158a may communicate data in the form of electrical signals to and from the controller 118 and the battery management system 302 via one or more of the electrical ports 194a-194e (e.g., electrical port 194a). Similarly, the secondary charger 158b may communicate data to and from the computing device 308 via one or more of the electrical ports 194a-194e (e.g., electrical port 194b). Additionally, the primary charger 158a and the secondary charger 158b may communicate data to and from one another via one or more of the electrical ports 194a-194e (e.g., electrical ports 194a).

The battery management system 302 may communicate data to and from the battery 304. The battery 304 is coupled electrically, communicatively, or both with the primary charger 158a via the battery management system 302. The battery management system 302 can serve as the central gatekeeper for charging the battery 304 and delivering power from the battery 304 to the material handling vehicle 100 (shown in FIG. 1). The battery management system 302 can include a processor, a memory, and one or more sensors configured to determine current draw, voltage, and whether communicative connection is established between other elements such as the battery 304. The battery management system 302 can be programmed to control battery charging from the primary charger 158a and the secondary charger 158b. The battery management system 302 can also be programmed to control the delivery of power to the material handling vehicle 100. For example, the battery management system 302 can control the delivery of power to the controller 118, and subsequently other components of the material handling vehicle 100, such as the wheel motors 310 that control forward movement of the material handling vehicle 100. Specifically, the battery management system 302 can establish or cut off power to the aforementioned elements in certain instances, such as in the event that the battery management system 302 detects a safety hazard. The battery management system 302 can also calculate the state of charge (SOC) value of the battery 304 and store data from the one or more sensors in the memory.

The controller 118 further includes a processor 320, a memory 322, and a display 324. Additionally, the controller 118 may communicate signals to and from the wheel motors 310. Further, a user can selectively program (e.g., code, instruct, modify, etc.) the controller 118, the charger assembly 132, and the battery management system 302 via the computing device 308. The controller 118, the charger assembly 132, and/or the battery management system 302 are programmable to charge different battery types (e.g., lithium ion, lead acid, nickel metal hydride, etc.). For the purpose of defining and describing the present disclosure, it is noted that the term “processor” generally means a device that executes functions according to machine-readable instructions or that has been configured to execute functions in a manner analogous to machine-readable instructions, such as an integrated circuit, a microchip, a computer, a central processing unit, a graphics processing unit, field-programmable gate array (FPGA), an application-specific integrated circuit (ASIC), or any other computation device. Additionally, it is noted that the term “memory,” as used herein, generally means one or more apparatus capable of storing data or machine-readable instructions for later retrieval, such as, but not limited to, RAM, ROM, flash memory, hard drives, or combinations thereof.

The interlock 312 is configured to detect when the material handling vehicle 100 (shown in FIG. 1) is being charged. More specifically, the interlock 312 determines whether the charger assembly 132 is receiving AC power from the AC power source 306 based on signals from the primary charger 158a. If the interlock 312 determines that the charger assembly 132 is plugged into and receiving AC electrical power from the AC power source 306, the interlock 312 prevents the controller 118 from sending signals for traction control, e.g., control of the wheel motors 310. Thus, when the interlock 312 detects that the material handling vehicle 100 is being charged, the interlock 312 stops the material handling vehicle 100 from being able to travel. In some forms, the interlock 312 will only prevent operation of the material handling vehicle 100 if the interlock 312 detects that the material handling vehicle 100 is being charged and one or both of the seat belt 126 is buckled or the operator presence sensor of the driver's seat 114 detects the operator.

In other embodiments, other configurations are possible. For example, those of skill in the art will recognize, according to the principles and concepts disclosed herein, that various combinations, sub-combinations, and substitutions of the components discussed above can provide appropriate control for a variety of different configurations of material handling vehicles, work machines, operator control systems, and so on, for a variety of applications.

The previous description of the disclosed embodiments is provided to enable any person skilled in the art to make or use the disclosure. Various modifications to these embodiments will be readily apparent to those skilled in the art, and the generic principles defined herein may be applied to other embodiments without departing from the spirit or scope of the disclosure. Thus, the disclosure is not intended to be limited to the embodiments shown herein but is to be accorded the widest scope consistent with the principles and novel features disclosed herein.

What is claimed is:

1. A material handling vehicle, comprising:
a body defining an outer perimeter; and
a charger assembly pivotably and removably mounted to the body, wherein in a closed configuration, the charger assembly is disposed fully within the outer perimeter.

2. The material handling vehicle of claim 1, wherein the charger assembly is pivotably mounted to a support post of the body via a clamp-on bracket assembly.

3. The material handling vehicle of claim 2, wherein the clamp-on bracket assembly is removable from the support post.

4. The material handling vehicle of claim 2, wherein the clamp-on bracket assembly includes a bracket configured to partially wrap around the support post.

5. The material handling vehicle of claim 4, wherein the clamp-on bracket assembly includes a spacer coupled to the bracket.

6. The material handling vehicle of claim 2, wherein the charger assembly is removable from the clamp-on bracket assembly via a hinge pin.

7. The material handling vehicle of claim 6, wherein a hinge fork of the charger assembly pivotably engages the clamp-on bracket assembly and the hinge pin.

8. The material handling vehicle of claim 1, wherein a clamp-on bracket assembly mounted to a support post of the body latchably receives the charger assembly.

9. The material handling vehicle of claim 8, wherein a latch plate of the charger assembly is slidably received by a latch lobe extending from the clamp-on bracket assembly.

10. The material handling vehicle of claim 1, wherein the charger assembly is retained in the closed configuration via a spring pin mounted to the body and engaging the charger assembly.

11. The material handling vehicle of claim 10, wherein the spring pin engages one of a latch plate and a hinge fork of the charger assembly.

12. The material handling vehicle of claim 1, wherein an alternating current electrical plug extends rearwardly from the charger assembly.

13. The material handling vehicle of claim 1, wherein a charger is disposed in a housing of the charger assembly.

14. The material handling vehicle of claim 13, wherein electrical ports of the charger are oriented downwardly.

15. The material handling vehicle of claim 13, wherein a top panel of the housing includes vents.

16. A material handling vehicle, comprising:
a body; and
a charging system including:
a charger assembly pivotably and removably mounted to the body, the charger assembly including:
an alternating current electrical plug, and
a charger in electrical communication with the alternating current electrical plug, and
a controller mounted to the body and in electrical communication with the charger.

17. The material handling vehicle of claim 16, wherein the controller includes an interlock configured to prevent movement of the material handling vehicle when an alternating current power source is connected to the alternating current electrical plug.

18. The material handling vehicle of claim 16, wherein the charger includes a plurality of electrical ports extending downwardly.

19. A charger assembly, comprising:
a housing including:
a top panel configured to provide ventilation,
a front panel defining a first opening for electrical cables,
a side panel defining a second opening configured as a handle, and
a hinge flange configured to removably and pivotably engage a bracket; and
a charger mounted within the housing and including a plurality of electrical ports extending downwardly.

20. The charger assembly of claim 19, wherein an alternating current electrical plug supported by the housing is in electrical communication with the charger.
